(19) United States
(12) Patent Application Publication
(10) Pub. No.: US 2013/0341878 A1
(43) Pub. Date: Dec. 26, 2013

(54) Instant Work Station

(71) Applicants: Carrie L Harris, Juneau, AK (US); David Edward Harris, Juneau, AK (US)

(72) Inventors: Carrie L Harris, Juneau, AK (US); David Edward Harris, Juneau, AK (US)

(21) Appl. No.: 13/304,622

(22) Filed: Nov. 26, 2011

Related U.S. Application Data
(60) Provisional application No. 61/547,769, filed on Oct. 17, 2011.

(51) Int. Cl. B62B 1/12; A47B 3/10

(52) U.S. Cl. CPC B62B 1/12; A47B 3/10
USPC 280/30

(57) ABSTRACT

An instant work station, a hand truck frame combined with an extendable table designed and configured to receive a number of accessories. The table lip is integrally formed to create a unitary, one-piece structure that also serves as a frame to add strength to the table. Numerous pre-existing pin holes and locking mechanism in the table frame and hand truck frame allow the user to select a wide number of accessories for the invention. This permits the user to adapt the invention to fit specialized needs. The invention also includes locking mechanism for the user to secure a tool box or utility box for storing and securing tools. Securing the accessories on the invention will increase efficiency and ease of transportation.

This application claims priority under 35 §U.S.C. 119(e) to U.S. Provisional Application No., 61/547/769 filed on Oct. 17, 2011, which is expressly incorporated by reference herein

### STATEMENT REGARDING FEDERALLY SPONSORED RESEARCH OR DEVELOPMENT.

There is no federally sponsored research or development related to this patent application or the development of the Instant Work Station

### BACKGROUND OF THE INVENTION

The present disclosure relates to a hand truck frame, and particularly to a convertible hand truck frame and expandable work table. More particularly, the present disclosure is related to a hand truck frame and expandable work table that can be reconfigured in the field by a user to function in any of several operating modes.

It would be desirable to have a portable work station with your tools that is compact enough to be carried in a car or on a city bus, while being sturdy enough to be used for a heavy load under 300 lb. Wherein on a work site eliminates the need for saw horses and plywood. Furthermore, it would be desirable to have a compact work table to use in smaller places. Still further, it would be desirable to have an easily portable work table that can be expanded in length or configured to the users needs in width. Still further, it would be desirable to have an easily portable work table with the users tool box or utility box securely attached. Therefore, there currently exists a need in the industry for a compact portable expandable work table.

This invention can be used in apartments that are being renovated or repaired such as hotels, restraints, schools, stores, and construction sites the list goes on. The portability of this invention ideal to take on any job that a work table is needed The portability and compact size with the ability for the user to securely attach a tool box or utility box allows users to save time, it is one unit to transport, making set up more efficient.

### DESCRIPTION OF THE RELATED ART

U.S. Pat. No. 4,565,382, this patent has cross legs and the wheels sitting on ground when the table is folded out. The down side of wheels on the ground when fully open is it can cause stability issues, the table has cross legs which do not allow for storage underneath the table. This invention was designed toward picnic and camping and does not appear that it would be able to withstand any significant amount of weight the wheels of this unit are positioned on the hand truck. On my invention the table sections when in the stowed position are stowed on the back side of the hand truck frame allowing more room on the load bearing side of the hand truck it would not be practical to have the wheels positioned and the hand truck frame although there is a place on the hand truck the user could place an additional wheel assembly if the user felt they need an additional set of wheels. Having the wheel on the legs on my invention lifts the entire unit and the table sections are not in the way.

U.S. Pat. No. 7,726,669 this invention collapse to a stowed position with manual pressure, a heavy weight could close the table. It has its wheels on the ground when open its nose plate flips to the inside and has telescoping rear legs and a telescoping handle. When in the stowed position the table is stowed at the front of the hand truck limiting space available for transportation of a tool box. The units table is expandable by attach another full unit to it decreasing the efficiency of having 1 portable expandable unit. Its wheels are located on the hand truck and rest on the ground the legs are telescoping compromising a heavy load support.

U.S. Pat. No. 2,748,004 when in the stowed position the table is stowed at the front of the hand truck limiting space available for transportation of a tool box the units, wheels are located on the hand truck and rest on the ground, the units table does not expand. The hand truck has an elongated frame.

U.S. Pat. No. 3,064,989 2wheels are located on the hand truck and rest on the ground, the units table does not expand, when in the open position the one pair of supporting legs rest on castors, this is a 4 wheeled collapsible cart frame. The angled support does not allow for items to be stored under the table.

U.S. Pat. No. 3,684,307 this invention is for office use it does not have an expandable table and sits on its wheels legs

U.S. Pat. No. 4,049,284 this invention is a garden cart this convertible hand cart has a folding box attached to the front of the hand truck.

there are many different types of convertible hand trucks the following patent numbers are referenced.
U.S. Pat. No. 5,257,892 Nov 4, 1991 Nov 2, 1993 Multiple purpose transporting device
U.S. Pat. No. 5,445,399 Aug. 17, 1993 Aug. 29, 1995 Retractable hand truck having positive leg lock
U.S. Pat. No. 6,158,749 Sep. 25, 1998 Dec. 12, 2000 Cosco Management, Inc. Step stool and dolly apparatus
U.S. Pat. No. 6,474,663 Jul. 7, 2000 Nov. 5, 2002 Combined pair of ladders and transportation dolly device
U.S. Pat. No. 4,284,286 Aug. 2, 1979 Aug. 18, 1981 Combination hand truck and portable work table
U.S. Pat. No. 6,578,856 Dec. 27, 2000 Jun. 17, 2003 Collapsible portable saw stand
U.S. Pat. No. 6,880,851 Sep. 27, 2002 Apr. 19, 2005 Deborah Dale Summers Lillian Marie Lyle Sharon Qucuilla Hand cart
U.S. Pat. No. 6,886,836 Dec. 5, 2002 May 3, 2005 universal mobile saw stand
U.S. Pat. No. 7,090,210 Aug. 4,2004 Aug. 15, 2006 Black & Decker lnc.Folding bench with hand truck capabilities
U.S. Pat. No. 7,168,712 Aug. 29, 2005 Jan. 30, 2007 Multi-function hand truck
U.S. Pat. No. 7,188,843 Aug. 29, 2001 Mar. 13, 2007 Multiuse lifting and rolling platform
U.S. Pat. No. 7,306,245 Apr. 4, 2005 Dec. 11, 2007 Multipurpose work site utility carrier
U.S. Pat. No. 7,306,245 Apr. 4, 2005 Dec. 11, 2007 Multipurpose work site utility carrier
U.S. Pat. No. 7,380,778 Jan. 8, 2007 Jun. 3, 2008 Black & Decker Inc. Wheeled folding bench with hand truck capabilities
U.S. Pat. No. 5,536,034 Oct. 12, 1994 Jul. 16, 1996 Convertible bulk hand truck and table top
U.S. Pat. No. 7,543,614 Mar. 13, 2007 Jun. 9, 2009 Collapsible infeed/outfeed table
U.S. Pat. No. 7,588,255 Nov. 10, 2005 Sep. 15, 2009 ZAG Industries, Ltd. Collapsible clamping work table
U.S. Pat. No. 7,726,669 Jan. 14, 2005 Jun. 1, 2010 Patricia Lynn Alexander Apparatus for a collapsible table and dolly
U.S. Pat. No. 7,971,898 Apr. 30, 2009 Jul. 5, 2011 Multiple link, self-jacking work cart
USD608969 Apr 30, 2009 Jan 26, 2010 Self-jacking four wheel cart

### BRIEF SUMMARY OF THE INVENTION

An instant work station, a hand truck frame combined with an extendable table designed and configured to receive a number of accessories. The table lip is integrally formed to create a unitary, one-piece structure that also serves as a frame to add strength to the table. Numerous pre-existing pin holes and locking mechanism in the table frame and hand truck frame allow the user to select a wide number of accessories for the invention. This permits the user to adapt the invention to fit specialized needs. The invention also includes locking mechanism for the user to secure a tool box or utility box for storing and securing tools. Securing the accessories on the invention will increase efficiency and ease of transportation.

### BRIEF DESCRIPTION OF THE SEVERAL VIEWS OF THE DRAWING

FIG. 1 is a drawing of the instant work station in the open position

FIG. 2 is a drawing of the instant work station turned upside down showing the bottom of the instant work station in the open position.

FIG. 3 is a sectional drawing of the instant work station in the stowed position and one of a polarity of locking mechanism that holds the instant work station in stowed position.

FIG. 4 is a sectional drawing of the instant work station and one of a polarity of locking mechanism's that secure a tool box or a utility box to the hand truck frame when setting on the nose plate.

FIG. 5 is a sectional drawing of the instant work station of the sliding support plate that slides under the pinch points of the table

FIG. 6 is a sectional drawing of the instant work station of the sliding support plate edge that wraps around the top of the table surface.

FIG. 7 is a sectional drawing of the instant work station of the sliding support plate, showing the movement of the slide plate

FIG. 8 is a sectional drawing of the wheel assembly and a leg.

FIG. 9 is a drawing of the instant work station a view of the table in the open position from the back.

FIG. 10 is a drawing of the instant work station a view of the table in the closed position from the back.

FIG. 11 is a drawing of the instant work station a view of the table in the open position from the front.

FIG. 12 is a drawing of the instant work station a view of the table in the closed position from the front.

FIG. 13 is a view some additional accessories that can be added to the table

FIG. 14 is a drawing of the instant work station in closed or in a stowed position.

FIG. 15 is a view some additional accessories that can be added to the users tool box or utility box table

FIG. 16 is a view showing how the accessories of FIG. 13 and FIG. 16 are attached

This application claims priority under 35 §U.S.C. 119(e) to U.S. Provisional Application No., 61/547/769 filed on Oct. 17, 2011, which is expressly incorporated by reference herein

### DETAILED DESCRIPTION OF DRAWINGS

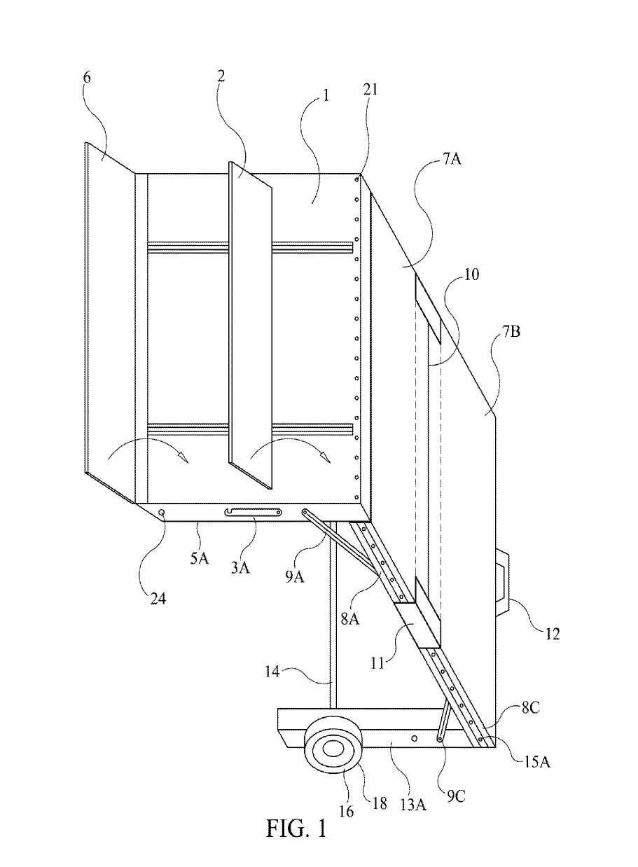

In FIG. 1 the Hand truck Frame 1 has a forward surface and a rearward surface. Extending from the lower end of the hand truck frame 1, and forwardly of the frame front is a folding toe plate 6 pivotally connected to the hand truck frame. The toe plate is of thin metal or other ridged material adapted to be loads to be moved.

In FIG. 1 The hand truck frame 1 has a second folding toe plate 2 it is pivotally connected to the hand truck frame adjacent to toe plate 6. The toe plate 2 is of thin metal or other ridged materials adapted to be positioned under a load or to be used as a shelf

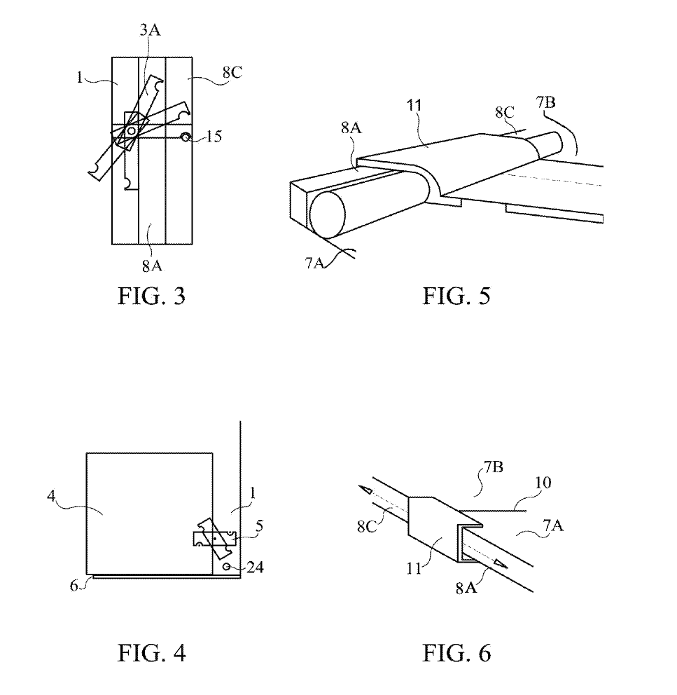

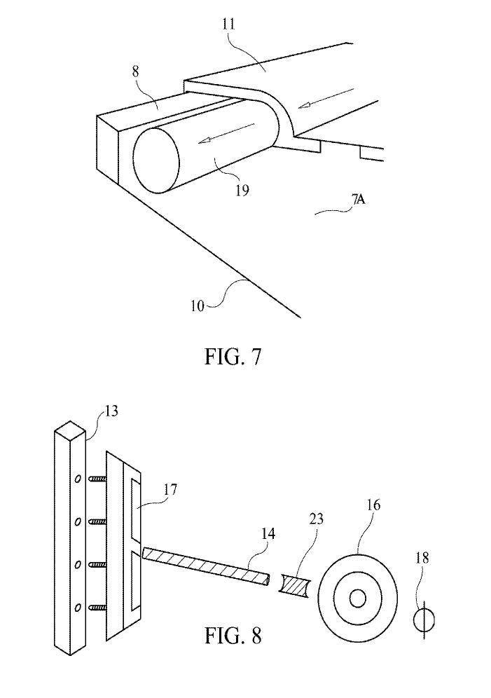

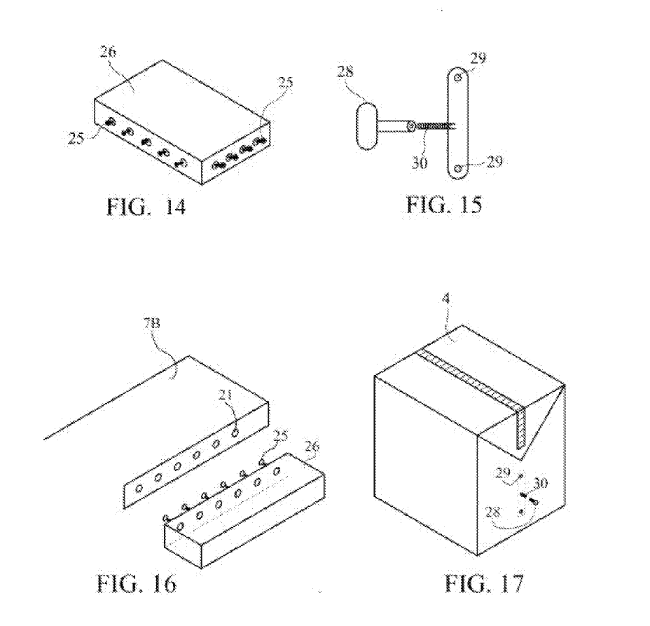

In FIGS. 1, 3, 14 The hand truck frame 1 on side 1(a) there is an attached locking mechanism 3(a). 15(a) a locking mechanism is pivotally attached on the lip 8(c). 3(a) attaches to 15(a) to secure the table and legs in a substantially vertical stowed position.

The hand truck frame on side 1(b) there is an attached locking mechanism 3(b). 15(b) a locking mechanism is attached on the lip 8(d). 3(b) attaches to 15(b) to secure the table and legs in a substantially vertical stowed position.

In FIGS. 1, 4, 14 The hand truck frame 1(side a) on frame 1 has a locking mechanism 5(a) pivotally attached for use with a utility box or tool box

The hand truck frame 1(side b) on frame 1 has a locking mechanism 5(b) pivotally attached for use with a utility box or tool box.

The hand truck frame 1 in FIGS. 1, 4, 14 has a pin hole 24 allowing the user to add an axel for a second set of wheels.

In FIGS. 1, 2, 14 table top sections, each table section is comprised of 4 sides an upper and lower surface, wherein a lip is integrally formed to create a unitary, one-piece structure on at least two sides. Table section 7 (a) wherein a lip is integrally formed to create a unitary, one-piece structure the lip are formed so the parallel lips envelope adjacent table surface lips, the table sections when stowed in a substantially vertical position may fold or slide out to horizontal open position. The table section lip 8(f) is pivotally mounted to the back side of the hand truck frame. The table section lips 8(a) and 8(b) are parallel table section. After the sliding support plate has been slid onto table section 7(a) table section 7(b) is pivotally attached to table section 7(a) the table sections being attaches so the parallel lips 8(a) an 8(b) meet the parallel lips of table section 7(b) parallel lips 8(c) and (8d). 8(e) is horizontal to the two parallel lips 8(c) and 8(d). 8 (e) is now parallel to 8(f)

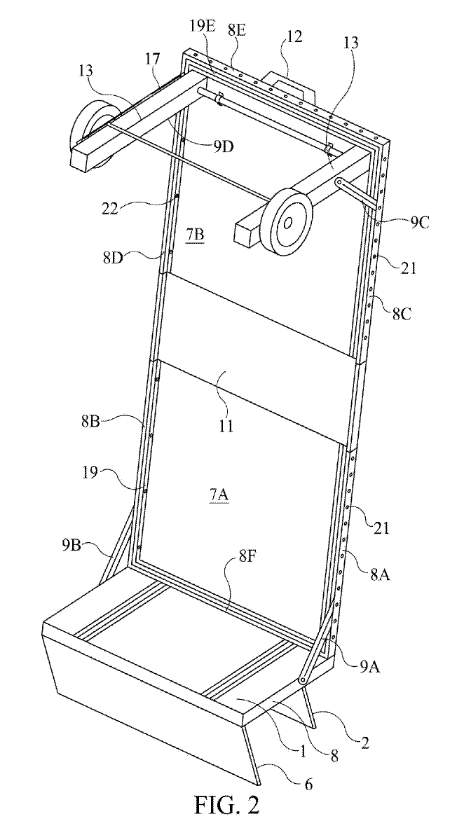

In FIG. 1 and 2 one end of support brace is 9(a) is pivotally mounted to hand truck frame 1 side (a) at or near the pivot axis. The adjacent end of support brace 9(a)is pivotally mounted to the table lip 8(a).

In FIG. 2 support brace 9(b) one end of the table support brace is pivotally mounted to hand truck frame 1 side (b) at or near the pivot axis. The adjacent end of support brace 9(b) is pivotally mounted to table lip 8(b).

In FIG. 2 one end of support brace 9(c) pivotally mounted to 13(a) the table leg at or near the pivot axis. The adjacent end of support brace 9(c) is pivotally mounted to the Table lip 8(c).

One end of support brace 9 (d) is pivotally mounted to 13(d) the table leg at or near the pivot axis. The adjacent end of support brace 9(d) is pivotally mounted to the table lip 8 (d).

In FIGS. 1,2,5,6,7 Center support plate lithe center support plate slides along the bottom of the instant work station when it is in the open position the center support plate 11 provides additional support at the pinch point 10 shown in FIG. 1 where table sections meet. The Center support plate is slid onto table section 7(a) prior to attaching table section 7(b)

In FIG. 5, 6,7 show a more detailed view of the center support plate 11

In FIG. 1, 2, 14 table top section 7 (b) wherein a male lip is integrally formed to create a unitary, one-piece structure on three sides the table section 7b is pivotally connected to 7(a). 7 (b) is connected to 7(a) on the side where the two parallel lip sections meet.

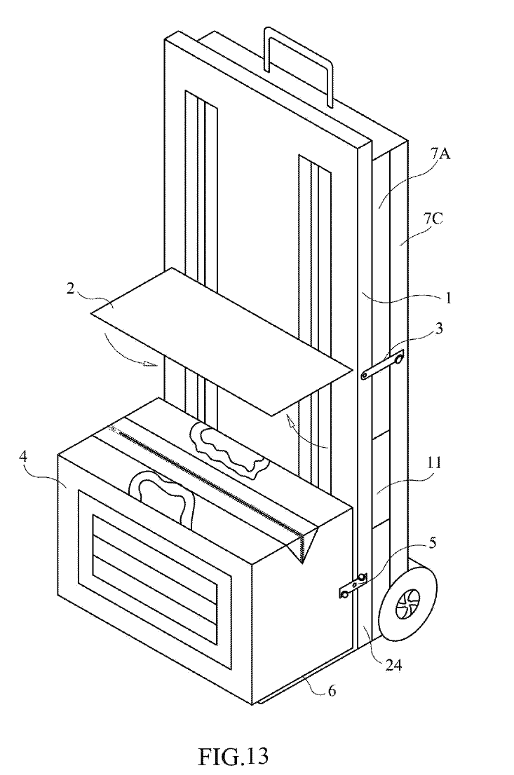

FIGS. 13a number of accessories that may be added table surface.

13(a) the additional table to add length to the table in the expandable form may be added by pivotally connecting the table section adjacent the end table section or adjacent the front of the hand truck frame.

13(b) a table surface to add width to the table the table surface has male pins that attach to the lip which slides into the female pin holes on the lip 8 (a,b,c,d,e) 13(c) shows and adjustable tool box utility box support that attaches to the front of the of the hand truck adjacent to nose plate 6 the toolbox utility box support has male pins that attach to the female pin holes.

In FIGS. 1, 2, 10, 12 the handle is connected to 8(e)

In FIGS. 1, 2, 14 Leg 13(a) is pivotally attached to table surface 7(b) near where the parallel lip 8(c) and the horizontal lip 8(e) meet

In FIG. 2 Leg 13(b) is pivotally attached to table surface 7(b) near where the parallel lip 8(d) and the horizontal lip 8e meet

In FIG. 8 the wheel assembly and position plate 17 is shown in greater detail the axel 14, the bushing 23, the wheel 16 are connected through the position plate 17.

Position plate 17(a) is mounted to leg 13(a) position plate 17(b) is mounted to leg 13(b)

The wheel axel 14 is pushed through position plate 17(a) and 17(b) leaving about equal lengths of the ends sticking out of each position plate.

There are 2 bushings 23, 1 bushing is place at each end of the axel on the outside of the position plate.

There are 2 Wheels 1 wheel is slid onto each end of the axel adjacent to the bushings.

There are 2 hitch pins 18 or similar locking device. Attach 1 hitch pin through the hole in the remaining portion of the axel outside the each wheel.

In FIG. 8 the wheel assembly and position plate 17 are shown in greater detail the axel 14, the bushing 23, the wheel 16

As illustrated in FIGS. 10, 12, and 14 the table converts into a hand truck when in the closed position. As in FIGS. 10, 12 and 14 the wheel 16 rotatable connected to the lower portion of the support leg 13(a) rotated in the lower position or the first position

As illustrated in FIGS. 10, 12, 14 the table converts into a hand truck when in the closed position. As in FIGS. 10, 12, and 14 the wheel 16 rotatable connected to the lower portion of the support leg 13(b) rotated in the lower position or the first position.

As illustrated in FIGS. 1, 2, 9, and 11 the portable workstation/instant workstation when in the open position the wheels are not setting on the ground and are rotated in a higher position or position.

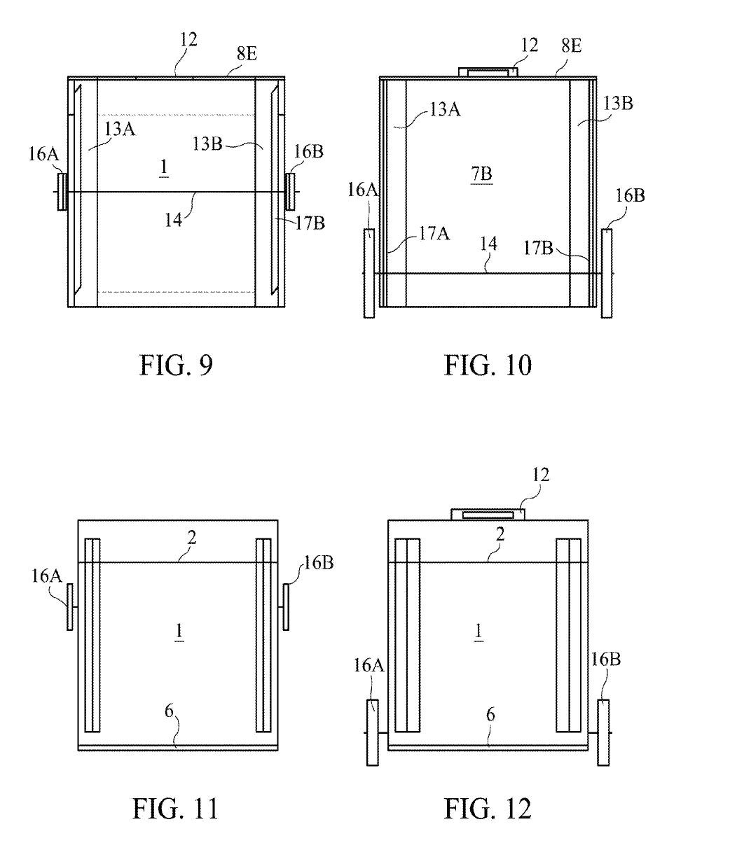

As illustrated in FIGS. 2, 9, and lithe portable workstation/instant workstation when in the closed position the wheels rotated in the lower position.

In FIG. 2 a frame 19 the frame is connected to the table for additional stability if the user feels he needs more stability or chooses to add additional table surfaces preferably the frame for each sections is male or female so they slide into each other.

in FIGS. 1, 2 a polarity of female fasteners 21 throughout the table lips and hand truck frame allow for additional table extensions and accessories to be attached. Additional accessories have a polarity of male fasteners that attach to the female holes or fasteners located throughout the table lips and on the hand truck frame.

FIGS. 13 number of accessories that may be added table surface. 13 the additional table section 26 can be used to add length to the table in the expandable form 25 is a male pin with a head that is inserted into any of the female pin holes 21 along the lip edge connecting the table section adjacent the end table section or adjacent the front of the hand truck frame. surface has male pins that attach to the lip which slides into the female pin holes on the lip any portion of 8 (a,b,c,d,e)

FIG. 15 shows an adjustable tool box utility box support that attaches to the front of the of the hand truck adjacent to nose plate 6 the toolbox utility box support has male pins that attach to the female pin holes.

FIG. 16 shows a male pin that may be attached to the users tool box or utility box.

This invention can be made with any rigged materials or a combination of rigged materials preferably light weight such as plastic or aluminum.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of the skill in art relying upon the disclosure in this specification and the attached drawings.

What I claim.

1. A Instant Work Station comprising
a hand truck frame, supporting back frame, a nose plate or a polarity of nose plates pivotally attached to frame, an extending table, a handle, legs and wheels.

2. A hand truck and table comprising a hand truck support frame connected to the first of a polarity of extendable table sections wherein the extendable table sections are pivotally connected to adjacent table section, wherein each extendable table section is movable from a substantially vertical stowed position adjacent one of the sides or ends to a substantially horizontal extended position.

3. Each table section is comprised of 4 sides an upper and lower surface, wherein a lip is integrally formed to create a unitary, one-piece structure on at least two sides, Additional table extensions can be added they are comprised of 4 sides an upper and a lower surface two lips running parallel.

4. A polarity of legs movable between an extended position and a collapsed position relative to the position of the table section.

5. Adjustable vertical wheel assemblies is positioned on a polarity of legs.

6. As in claim 1 the hand truck frame in has two adjacent folding nose plates both with load bearing capability's both are pivotally attached to the frame of the hand truck, the hand truck frame has locking mechanism on each side to secure a tool box or a utility box.

7. As in claim 1 there are polarities of locking mechanisms to lock the adjacent folding nose plates in the collapsed position, a polarity of locking mechanism on the frame of the hand truck adjacent to the nose plate to add additional support for a tool box or utility box.

8. As in claim 1 the portable hand truck frame a polarity of pin holes on each side of the frame to allow the user to add an additional axel and wheel assembly.

9. As in claim 2 the first table section is comprised of one lip running horizontal and two lips running parallel to each other, the last table section is comprised of one lip running horizontal and two lips running parallel to each other, wherein the first table sections is pivotally mounted on the hand truck frame, a locking mechanism is attached on each parallel side of the table surface lip and on the corresponding side of the hand truck frame, this mechanism supports the table when it is in the open position.

10. As in claim 2 wherein the table section are pivotally connected adjacent each table section, the first table section lip running horizontal movably attached to the hand tuck frame additional table section pivotally attached adjacent to the table section.

11. in As in claim 2 The last table section having three lips is movably attached adjacent to the first table section or the previous table section a telescoping handle is attached to the lip running horizontal to the parallel lips of the last table section.

12. As in claim 2 the table sections are movably attached adjacent the first table section at the pinch points they may fold to be stowed in a vertical position

13. As in claim 2 the table sections wherein in the stowed position the table sections are lifted or pulled into the open position, preferably the table section lips are formed so the parallel lips envelope adjacent table surface lips, the table sections when stowed in a substantially vertical position may fold or slide out to horizontal open position.

14. As in claim 2 A single or a polarity of movable sliding support plates is attached to the first table section this gives additional load bearing support to the pinch points where the table sections are connected.

15. As in claim 3 the lip of the table section is comprised of a polarity of locking mechanism to hold the table in the vertical stowed position.

16. As in claim 3 the lip of the table section is comprised of a polarity of locking mechanism to support the table in the open position.

17. As in claim 3 The lip of the table sections may also have a polarity of fasteners for additional table extensions, additional table extensions have a polarity of fasteners on one or all sides of the table extension.

18. As in claim 3 an additional support frame is generally disposed between the inner portion of the lip of each table section and the inner portion of the second portion of the lip while in the collapsed position the first support frame does not extend beyond a the table section edge that is aligned with the lower portion of the first portion of the lip and the lower portion of the inside portion of the lip, extendable table sections may have an additional frame secured with fasteners for added stability.

19. As in claim 4 the leg assembly two legs are secured to the last table section each leg near the corners of the last table section where the horizontal and parallel table lips meet, the two legs are secured with a support type mechanism to ensure they stay in the open position the mechanism also adds additional support to the table when the table is in the open position.

20. As in claim 1 in the hand truck is made of rigid material such as light weight plastic blow molded plastic, or a light weight metal such as aluminum, the table sections is made out of rigid materials such as light weight plastic, blow molded plastic, or a light weight metal such as aluminum.
